(19) United States
(12) Patent Application Publication
(10) Pub. No.: US 2020/0196143 A1
(43) Pub. Date: Jun. 18, 2020

(54) PUBLIC KEY-BASED SERVICE AUTHENTICATION METHOD AND SYSTEM

(71) Applicant: ESTORM CO., LTD., Seoul (KR)

(72) Inventors: Jong Hyun WOO, Seoul (KR); Hyung Seok JANG, Seoul (KR); Ho Jin JO, Gwangmyeong-si (KR); Joon Hyun LEE, Seoul (KR)

(73) Assignee: eStorm Co., LTD., Seoul (KR)

(21) Appl. No.: 16/321,040

(22) PCT Filed: Jun. 30, 2017
(86) PCT No.: PCT/KR2017/006994

§ 371 Date: Jan. 28, 2019

(30) Foreign Application Priority Data
Jul. 28, 2016 (KR) 10-2016-0096494

(51) Int. Cl. H04W 12/04; H04L 9/30; H04W 12/06

(52) U.S. Cl. CPC H04W 12/04; H04W 12/06; H04L 9/30

(57) ABSTRACT

An authentication system includes: an authentication server configured to perform an authentication procedure for an online service server and a mobile authentication application installed on a mobile device to perform an authentication procedure for a connection terminal connected to the online service server, wherein the authentication server generates a service authentication code in response to a service request of a user to the online service server through the connection terminal, transmits the service authentication code to the online service server such that the online service server discloses the service authentication code on a service screen, performs PKI(Public Key Infrastructure)-based encryption, and transmits an encrypted service authentication code or an encrypted service authentication code-related value to the mobile authentication application to enable the user to verify the service authentication code through a screen of the mobile authentication application.

### TECHNICAL FIELD

The present invention relates to an authentication method and system and more particularly, to a public key-based service authentication method and system.

### BACKGROUND ART

As dozens of online services and mobile devices are used in everyday life, next generation authentication technologies that can replace user authentication by using mobile devices are being introduced. One of the most representative technologies is user authentication technology such as biometric information recognizer attached to a user's smart phone and FIDO (Fast IDentity Online) applying PKI (Public Key Infrastructure) based technology.

The PKI-based user authentication technology using the mobile terminal generally operates in the following manner. Each time a user subscribes to a service, a user verification process such as biometric information registration is performed and a pair of asymmetric keys is generated in the mobile terminal. The secret key of the user is stored in the mobile terminal of the user and the public key of the user is transmitted to a service server. Thereafter, when the user accesses a corresponding service and inputs an ID, the service server transmits a predetermined or arbitrary trial value to the user terminal at the time of connection. When a personal verification process such as verification of a biometric value registered by the user is performed, the user terminal signs the received trial value with the user's private key and transmits it to the server. Therefore, the service server verifies a corresponding value using the public key of the user stored in the server, and performs a user authentication process to verify whether a rightful user has performed a user authentication with a rightful authentication terminal.

However, an existing mobile-based user authentication technology authenticates whether the rightful user connects to the service server through the rightful mobile authenticator, but cannot verify whether the service terminal currently used by the user is connected to a rightful service server to start the user authentication request.

For example, when a service application and an authentication application are driven separately from each other rather than in conjunction with each other in the mobile terminal or when a PC terminal accesses an on-line service through a web service and the authentication is performed for user connection by the authentication application of the mobile terminal, a request for user verification received from the mobile terminal may be performed without verifying whether the user accesses a normal service server through a normal service terminal.

Accordingly, when the request for user authentication is received from the service server by a terminal on which the user authentication application is installed, it is impossible to verify whether the service terminal is connected to a normal service and the user request is received. In this case, if the service terminal of a user is initially connected to a wrong service not a normal service server and at this time, a hacker inputs a user ID to the service terminal of the hacker, a user verification request is input to a mobile authentication application of a rightful user. In this case, there is possibility that the user mistakes the connection for his or her own connection and performs user verification to perform authentication for connection attempt of the hacker, not the user.

More specifically, when a user initially accesses a service through a service web site or a pharmed mobile application and inputs an ID in a service terminal, at that time, the hacker accesses the actual service server with the ID acquired by the hacker and inputs a user ID and a user authentication request is performed in the mobile authentication application terminal held by the user. In this case the user mistakes authentication request for his or her own connection and performs a user verification process such as input of a biometric value, and therefore, the service terminal of the hacker is authenticated by the rightful service server.

Accordingly, when the service and the authentication are operated separately through a mobile authentication device, the authenticate is performed without user confirmation of whether the authentication is started by the tampered service, thereby causing fatal problems in service security even when the applied user authentication technique is excellent in security.

Until now, there has been a method for verifying services based on a QR code and a method for verifying services based on a service one-time password (OTP) as an authentication method for confirming whether a user terminal has received a correct service.

The method for verifying services based on QR code is a method in which when a user accesses a service and inputs a user ID, the QR code generated by the service server is displayed on the user's service terminal, and a value detected using a camera of the user's mobile authentication application is transmitted to a service server. However, the method using the QR code has complexity due to camera sensing and limitation that a single mobile terminal cannot sense its own screen using its own camera in a mobile work environment where a user simultaneously uses a service application and an authentication application.

Also, the method for verifying services based on a service OTP is a method in which when a user accesses a service and inputs an ID, an OTP value generated by the service server is displayed on the user's service terminal, and an OTP value is generated through the user's mobile verification application, thereby verifying whether the service is a normal service. However, the method using the service OTP has limitation that the authentication value should be expressed only by numbers in accordance with OTP features, and the name of a connected service or a service item name (service name, transaction name, contract document, trader name, transaction amount, or the like) are not expressed such that the user directly checks the terms for comparison.

Therefore, there is a need for a PKI-based service authentication technology that allows a user to verify whether a user terminal is connected to a correct service server or a correct sub-service of a service and user authentication is started.

### DISCLOSURE

### Technical Problem

The present invention provides a method and a system for verifying whether a user terminal that is being used is connected to a correct service server and a user authentication is started.

More specifically, the present invention provides a method in which, when a user ID is input to a service server for user authentication after a user terminal is connected to a service, the service server generates a service authentication value, presents the service authentication value to the user terminal, encrypts a related value for generating a service authentication value or an authentication value using a PKI-based key and transmits the related value to an authentication terminal. Also, there are provided a service authentication method and system in which an authentication terminal verifies the corresponding value using the PKI-based key stored in advance, decrypts the value transmitted from the service, generates a service verification value or a service verification value based on the related value, and displays it to the user, to allow the user to visually confirm whether or not the user is connected to a rightful service server.

Herein, the PKI-based authentication server, which verifies service and user authentication, receives a user ID, generates a service authentication code according to predetermined conditions, provides the service authentication code to a service terminal of a user through the service server, encrypts a related value for generating a service authentication value or a authentication value using a PKI-based key, transmits the related value to the authentication terminal, decrypts the encrypted user authentication value received from an authentication application, and when the user authentication value is identical to a predetermined user authentication value, transmits an authentication success message to the service server.

The PKI-based authentication application, which is used in the service, decrypts the encrypted service authentication value received from the authentication server using a PKI-based key stored in advance in the authentication terminal, generate a service verification value based on a service verification value or a related value, discloses the service verification value to the user, enables the user to directly check whether the service terminal is connected to a rightful service server, generates a user authentication value according to predetermined conditions after a user verification process through user an agreement procedure, encrypts the user authentication value using the stored PKI-based key, and transmits the encrypted user authentication value to the authentication server.

### Technical Solution

According to an aspect of the present invention, there is provided a PKI-based authentication application and an authentication server which verify whether a service terminal currently used is connected to a correct service server and user authentication is started in constructing a mobile authentication technique using a PKI-based technology.

### Advantageous Effects

According to an aspect of the present invention, the user can explicitly check whether the user terminal currently used by the user is connected to the correct service server and the user authentication is started, thereby being able to prepare for authentication request due to a man-in-the-middle attack in using the mobile authentication technique using the PKI-based technology.

According to another aspect of the present invention, a user terminal and an authenticator application are driven in conjunction with each other in a single terminal, not driven separately from each other based on a QR code, thereby configuring a more secure mobile-based authentication environment.

According to another aspect of the present invention, it is advantageous that the name of a connected service or a service item name suggested by the service are directly expressed to the user in authenticating the service to enable a user to check the corresponding service semantically, beyond the limitation that the OTP (one-time password) has to be expressed only by numbers.

### DESCRIPTION OF DRAWINGS

FIG. 1 is a diagram for describing a PKI-based service authentication method and system according to embodiments of the present invention.

FIGS. 2 to 7 are exemplary screens displayed on a screen during performance of authentication according to the PKI-based service authentication method according to embodiments of the present invention.

### BEST MODE

The present invention is capable of various modifications and various embodiments, and specific embodiments are illustrated in the drawings and described in detail in the detailed description. It is to be understood, however, that the invention is not to be limited to the specific embodiments, but includes all modifications, equivalents, and alternatives falling within the spirit and scope of the invention.

In the following description of the present invention, detailed description of known related arts will be omitted when it is determined that the gist of the present invention may be unnecessarily obscured. In addition, numerals (e.g., first, second, etc.) used in the description of the present invention are merely an identifier for distinguishing one component from another.

It will be understood that, throughout the specification, when an element is referred to as being “connected to” or “coupled to” another element, the element may be directly connected or directly coupled to the other element, but, unless explicitly described to the contrary, the element may be connected or coupled to the other element or intervening elements may be present. In addition, throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof. Also, a Push ID described in the present specification refers to a Push Token typically expressed by mobile app developers and a push message service refers to a message service provided for each app in a mobile operating system, such as Google or Apple.

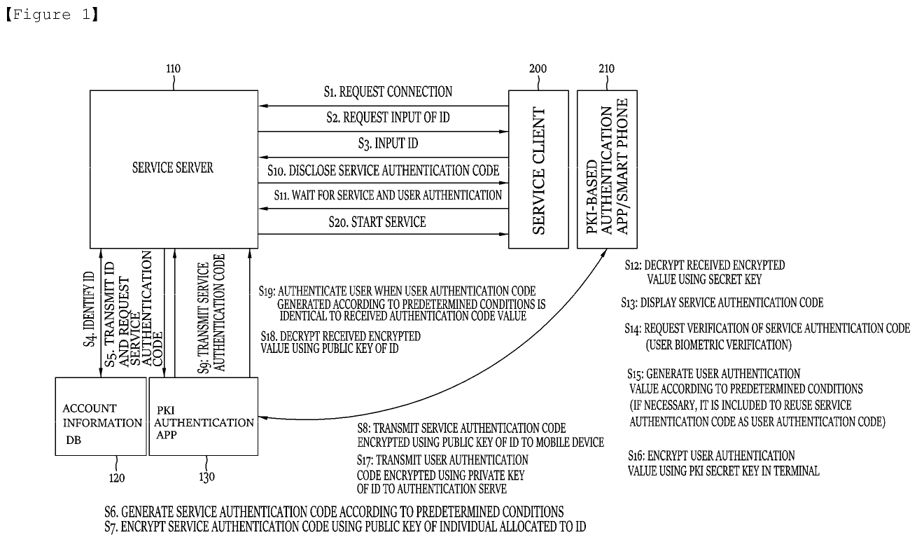

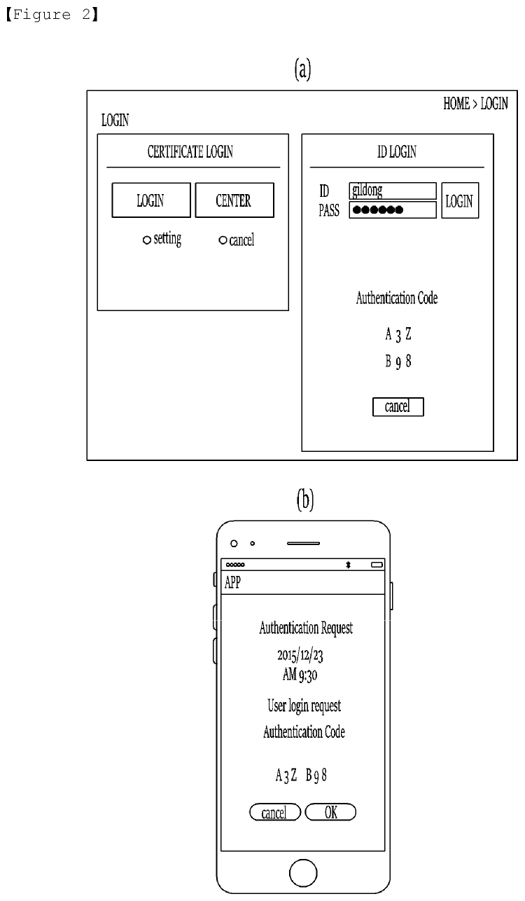

FIG. 1 is a diagram for describing a PKI-based service authentication method and system according to embodiments of the present invention and FIGS. 2 to 7 are exemplary screens displayed on a screen during performance of authentication according to the PKI-based service authentication method according to embodiments of the present invention. Hereinafter, embodiments of the present invention will be described in detail with reference to FIG. 1 and FIGS. 2 to 7.

Referring to FIG. 1, a PKI-based service authentication system according to an embodiment of the present invention may include a service server 110 which provides a service to clients, an account information database (DB) 120, a PKI-based authentication server 130, a service client 200 which is connected to access the service server, and an authenticator app 210 which performs PKI-based authentication.

The service client 200 is a computing device used by a user to access the service server 110 and collectively refers to various types of terminals, such as a PC, a smart phone, or the like of a user. In addition, the authenticator application 210 refers to an application program (that is, an agent program for authentication) produced for the purpose of performing service authentication and user authentication according to an embodiment of the present invention. It is, of course, possible that the authenticator application 210 is directly installed on a user's own authentication terminal (e.g., a smart phone or the like), but is separately provided as a dedicated authentication terminal. It is apparent that the service client 200 may be a web browser of a PC configured separately from the PKI-based authenticator app 210, a mobile service application, or a mobile application into which the service client 200 and the PKI-based authenticator application 210 are integrated. It is also apparent that the account information DB 120 may also be integrated with the service server 110 and operated according to an implementation method.

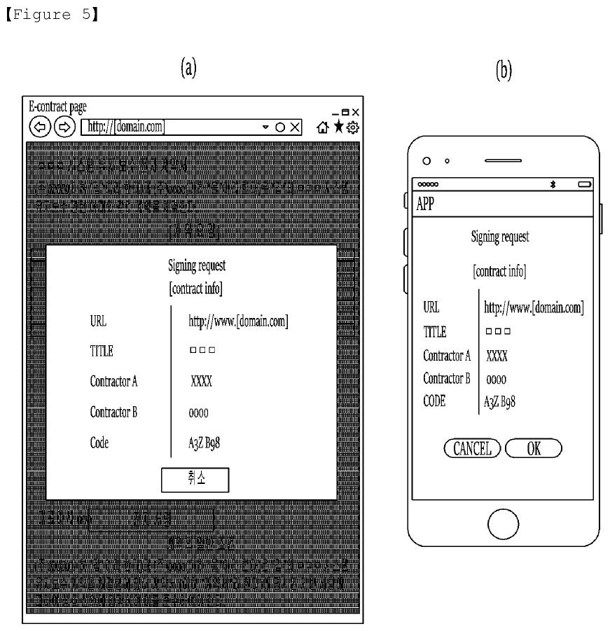

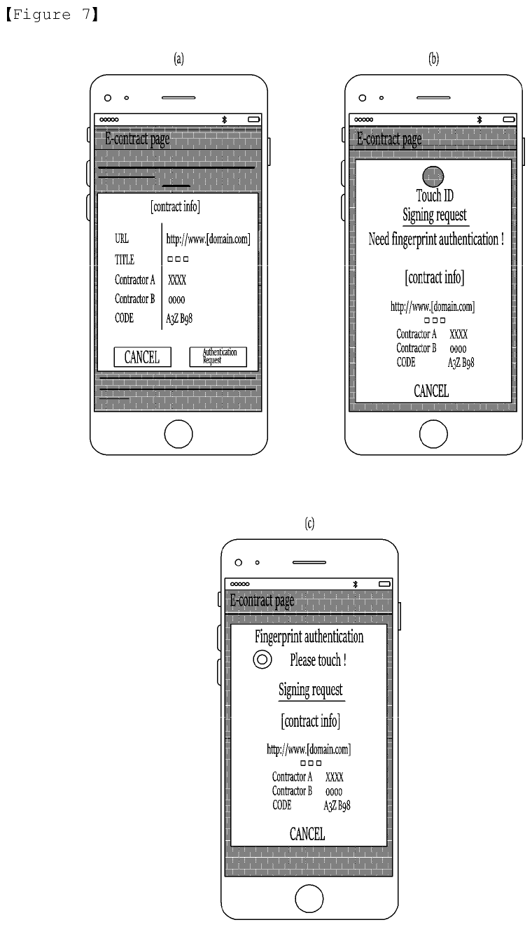

Although the service client 200 and the authenticator application 210 are illustrated as physically separated objects in FIG. 1, it is not necessary to implement them as illustrated. For example, the service client 200 and the authenticator application 210 may be implemented in the one object when the service client 200 is a smart phone of a user and the authenticator application 210 is installed on the smart phone. With reference to the accompanying drawings of the present specification, FIGS. 2, 4, and 6 illustrate a case in which the service client 200 is a specific service terminals used by a user such as a PC, and the authenticator application 210 is installed on a smart phone held by the user. In this case, the service client 200 is connected to the service server 110 through a web application and the authenticator application 210 performs service authentication and user authentication operations in a mobile environment (first case according to an embodiment of the present invention). As another example, FIGS. 5 and 7 illustrate a case in which the service client 200 is a smart phone held by the user and the authentication application 210 is installed on the smart phone. In this case, connection to the service server 110 and authentication operations will be all performed in a mobile environment (second case according to an embodiment of the present invention).

The service server 110 is a configuration part which corresponds to a request of the service client 200 and provides an actual service. When a client attempts connection initially, the service server 100 request a user ID (see S1 and S2 of FIG. 1). When the ID is identified from the account information DB 120 (see S3 and S4 of FIG. 1), the service server 1110 transmits the corresponding ID to the PKI authentication server 130 and requests a service authentication code (see S5 of FIG. 1).

In this case, it is apparent that, when the base technology used as the PKI is based on a situation where the authentication application 210 is being operated, a push message indicating that an authentication request has been received through a separate push server (not shown) is transmitted to the PKI-based authentication API 210 after identification of the ID from the account information DB 120, and when a signal indicating that the user who has received the push message has started the application is received, the authentication code request can be performed along with transmission of the ID.

In addition, in requesting the service authentication code, another service server may request an authentication code with the name of a function to be performed beside the service authentication code. That is, the service server transmits the name of an operation which is wanted to be authenticated the service server. For example, it is possible to add ‘login’ to a site URL as a function name and perform transmission at the time of transmission of the ID or it is possible to additionally transmit a contract name, a contract file location, a contract document file, contracting parties and so on when authentication is to be received with respect to a specific contract.

The PKI authentication server 130 may generate the service authentication code according to predetermined conditions (see S6 of FIG. 1). In this case, a predetermined condition may be to generate an arbitrary number, to generate an OTP value of a corresponding ID as a symmetric key designated in advance for each user such as OTP, to generate ‘Contract 2016-serial number’ or the like according to a contract number generation rule designated in advance, or to generate any format of character string previously designated, such as a character string for requesting service authentication from the service server, for example, ‘site name (for example, estorm.co.kr), function name Login’.

Thereafter, the PKI authentication server 130 encrypts the generated service authentication code using a public key allocated previously corresponding to an ID of a receiver and transmits the encrypted service authentication code to a terminal on which the PKI-based authentication application 210 of the corresponding ID is installed (see S7 and S8 of FIG. 1) In this case, it is apparent that transmission is possible using any type of communication methods, such as socket communication, push messages, or the like.

In addition, the PKI authentication server 130 may disclose the service authentication code to a user through a screen provided by the service server 110 by transmitting he generated service authentication code to the service server 110 (see S9 and S10 of FIG. 1) In this case, screen waiting related to service authentication and user authentication is performed (see S11 of FIG. 1).

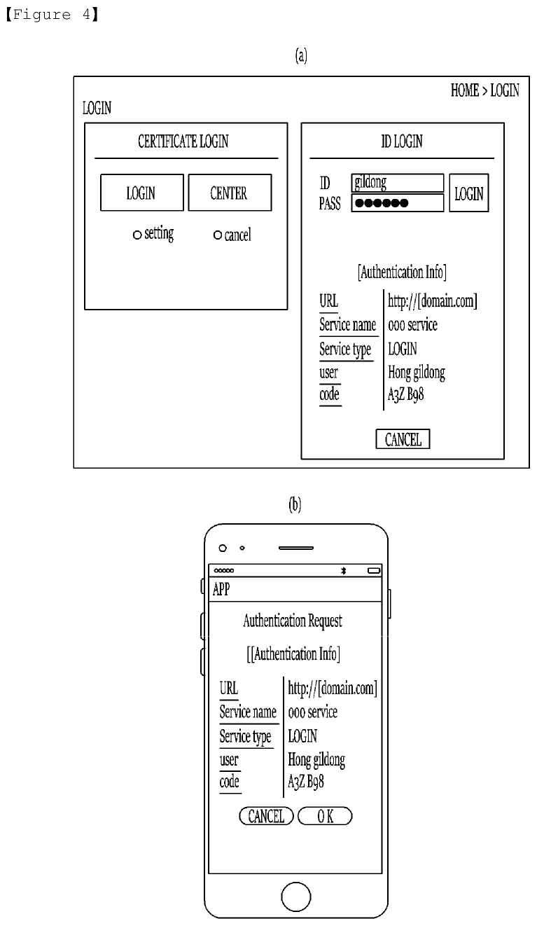

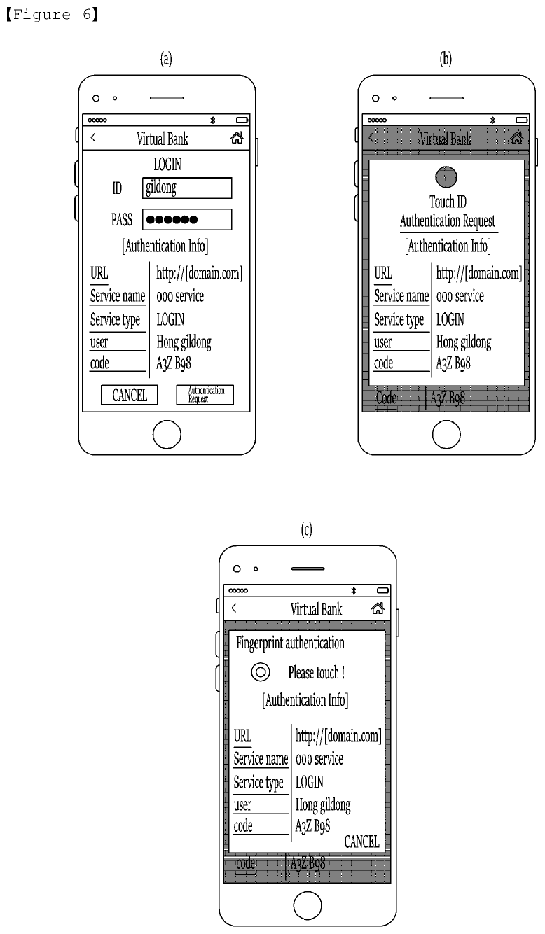

An example of a screen related to disclosing of the service authentication code through the screen provided by the service server 110 is illustrated in (a) of FIG. 2. Other examples of the screen are illustrated in (a) of FIG. 4 and (a) of FIG. 5, in which other information related to service connection (that is, a URL of the service server, a service name, authentication propose, a user who requests authentication, or the like) are further provided along with the service authentication code. Still another examples of the screen are illustrated in (a) of FIG. 6 and (a) of FIG. 7 (a), in which other information related to a corresponding contact (that is, a contract location, a contract name, a contract number, contractor, covenantee, contract content values or the like) are further provided along with the service authentication code (contract authorization code in the present example).

Accordingly, the PKI-based authentication application 120 decrypts the transmitted encrypted value using its own secret key, displays the service authentication code to enable the user to identify the service authentication code by processing a corresponding character string according to a predetermined method, and requests agreement from the user (see S12, S13, and S14 of FIG. 1). In this case, the decrypted character string may be an authentication value itself for service authentication, an OTP generation variable capable of generating a service authentication value, a character string obtained by combining a site name with a function name, a character string in which a contact amount and a contractor name are indicated in a contact number, or the like.

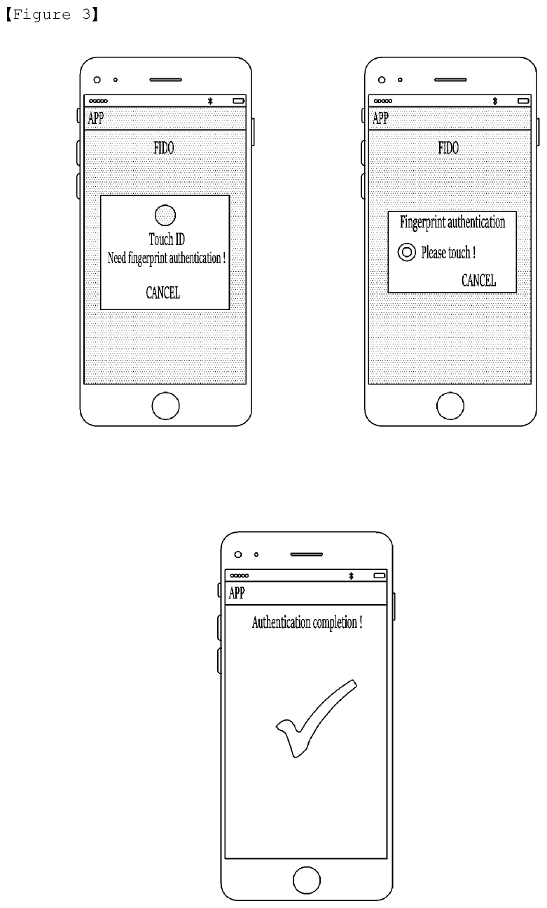

Here, a user agreement method may be variously applied according to a previously defined method in verifying the service authentication code. For example, it is obvious that the user agreement may be made by using a variety of user identification functions that can be performed in a smart phone, such as fingerprint recognition, voice recognition, face recognition, and PIN verification. FIG. 3 illustrates a method of identifying a user through fingerprint recognition as an example of the above-described user identification function.

When the authentication code of the user is verified, the authentication application 210 generates a user authentication value according to the predetermined conditions (see of S15 of FIG. 1), encrypts the user authentication value using a private key of a corresponding ID available in the authentication application, and transmits it to the authentication server 130 (see S16 and S17 of FIG. 1). In this case, it is obvious that the predetermined condition is to use a character string received at the time of authentication as it is, to change a received character string by applying an arbitrary variable, such as a time, to the received character string, or to generate a user authentication value according to the same condition prearranged with a server for user authentication.

The PKI authentication server 130 decrypts the encrypted value transmitted by the authentication application 210 using the public key of the corresponding ID, compares the decrypted value with a user authentication code generated according to the predetermined conditions, verifies that data is transmitted from authentication application 210 when the decrypted value is identical to the user authentication code, and thereafter transmits a result of authentication (That is, authentication approval) to the service server (see S18 and S19 of FIG. 1). The service server starts the service according to the authentication approval (see S20 of FIG. 1). For example, when the authentication purpose is login, the service access will be approved by the user, and when the authentication purpose is conclusion of a contract, the conclusion of a contract will be approved according to the agreement of the user.

In the above description, a service authentication value is encrypted using the public key of a user stored in the PKI authentication server and is then decrypted using the private key of the user in the PKI authentication application. On the other hand, it is obvious that the PKI authentication server encrypts the service authentication value using a secret key of the server and the PKI authentication application decrypts the service authentication value using the public value of the server. That is, the service authentication is performed in such a way to start the service authentication with the secret key of the server, decrypt the service authentication value using the public key of the server which is stored in the PKI authentication application, request a user to give agreement by enabling the user to verify whether the service authentication values displayed on a service screen and an authentication device screen are identical to each other, and when the user performs verification, generate a user authentication value in a predetermined method in the user own PKI authentication application, encrypt the user authentication value using an available user private key, and transmit the user authentication value to the PKI authentication server.

In addition, when the service server implements a service in which signature is performed using the user's private key with respect to a contact instead of user authentication, an electronic contact file may be transmitted to the PKI authentication server along with the ID, entirely similarly to but differently from the above-described flow. In this case, the PKI authentication server generates a hash value of a corresponding contact file, encrypts the hash value using a public key of a user and transmits the hash value to the PKI authentication application. The PKI authentication application decrypts the hash value using its own secret key, when user agreement is made, encrypts the hash value using the secret key of the user and transmits the hash value to the PKI authentication server. Therefore, the PKI authentication server decrypts the received encrypted hash value using a public key of a corresponding user and compares the received hash value with a hash value transmitted from the server. When the received hash value is identical to the hash value transmitted from the server, the PKI authentication server informs the service server of conclusion of the contract.

According to configurations, it is apparent that it is possible to achieve by a manufacturer so in a case in which a user agreement method is a biometric recognition function, such as a fingerprint recognition function installed in a mobile device, when a fingerprint reader of a manufacturer is displayed on a screen, a service provider or a function name of the service provider are displayed together, thereby relevant screen examples are illustrated in (b) and (c) of FIG. 5 and (b) and (c) of FIG. 7.

The above-described public key-based service authentication method according to the embodiments of the present invention may be implemented by computer-readable codes stored in a computer-readable storage media. The computer-readable storage media may include all kind of storage media to which data read by a computer or the like is stored. Examples of the computer-readable storage media include a ROM (Read Only Memory), a RAM (Random Access Memory), a magnetic tape, a magnetic disk, a flash memory, and an optical data storage. Moreover, the computer-readable storage media may be a distributed storage media distributed to computer systems interconnected to each other through a computer communications network, and the computer-readable codes are stored to be executed in the distributed storage media in a form of distributed codes.

While the invention has been shown and described with respect to the embodiments, it will be understood by those skilled in the art that various changes and modification may be made without departing from the scope of the invention as defined in the following claims.

1. An authentication system comprising:
an authentication server configured to perform an authentication procedure for an online service server and a mobile authentication application installed on a mobile device to perform an authentication procedure for a connection terminal connected to the online service server,
wherein the authentication server generates a service authentication code in response to a service request of a user to the online service server through the connection terminal, transmits the service authentication code to the online service server such that the online service server discloses the service authentication code on a service screen, performs PKI(Public Key Infrastructure)-based encryption, and transmits an encrypted service authentication code or an encrypted service authentication code-related value to the mobile authentication application to enable the user to verify the service authentication code through a screen of the mobile authentication application.

2. The authentication system according to claim 1,
wherein the authentication server receives account information of the user transmitted by the connection terminal from the online service server, and encrypts the generated service authentication code or the service authentication code-related value using any one of a public key previously allocated corresponding to the account information of the user and a server private key of the authentication server,
wherein the mobile authentication application decrypts the encrypted service authentication code or the encrypted service authentication code-related value which is received using any one of a secret key used corresponding to the account information of the user and a public key previously allocated corresponding to the authentication server, and discloses the service authentication code through a screen of the application to perform service authentication through the user's verification of the service authentication code.

3. The authentication system according to claim 2,
wherein the service authentication through the verification of the service authentication code is implemented in integrated with a FIDO (Fast Identity Online)-based authentication method.

4. The authentication system according to claim 2,
wherein the mobile authentication application generates a user authentication value according predetermined conditions and transmits a generated user authentication value to the authentication server when the service authentication through the verification of the service authentication code has been completed,
wherein the authentication server generates an authentication value for verification using a same generation condition as a generation condition of the user authentication value, performs user authentication by performing comparison of the received user authentication value with the authentication value for verification, and transmits a result of the authentication performance to the online service server.

5. The authentication system according to claim 1,
wherein the authentication server generates the service authentication code according to predetermined conditions by using corresponding service-related information received from the online service server,
wherein the service-related information is disclosed along with the service authentication code through the service screen of the online service server and a screen of the mobile authentication application.

6. The authentication system according to claim 5,
wherein, when authentication purpose is connection authentication, the service-related information includes at least one of a web address of the service server, a connection service name, the authentication purpose, and a person who requests authentication.

7. The authentication system according to claim 7,
wherein, when authentication purpose is contact authentication, the service-related information includes at least one of a contract name, a contract number, contractor, covenantee, and content values of the contract.
